(19) United States
(12) Patent Application Publication
(10) Pub. No.: US 2024/0178485 A1
(43) Pub. Date: May 30, 2024

(54) Battery Pack Support And Battery Pack

(71) Applicant: DuPont Polymers, Inc., Wilmington, DE (US)

(72) Inventors: Fabrice S. J-M Giaume, Peillonnex (FR); Bryan Martin Morris, Coppet (CH); Mattia Sulmoni, Meyrin (CH); Michel C. Renaud, Prangins (CH)

(21) Appl. No.: 18/551,884

(22) PCT Filed: Jun. 11, 2021
(86) PCT No.: PCT/US2021/037097

§ 371 Date: Sep. 22, 2023

Related U.S. Application Data
(60) Provisional application No. 63/169,410, filed on Apr. 1, 2021.

(51) Int. Cl. H01M 10/6568; H01M 10/613; H01M 50/209; H01M 50/227; H01M 50/507; H01M 50/516

(52) U.S. Cl. CPC H01M 10/6568; H01M 10/613; H01M 50/209; H01M 50/227; H01M 50/507; H01M 50/516

(57) ABSTRACT

Battery pack structural assembly (2) comprising a plurality of transverse support devices (5) between which one or more groups of stacked battery cells (3) may be mounted and electrically interconnected, each transverse support device comprising a support frame (6) and a plurality of battery connection plates (16) mounted on the support frame, the battery connection plates having a conductive surface facing an outer side of the transverse support, the support frame comprising chambers (8) formed therein interconnected fluidically to form at least one channel for circulation of cooling fluid through the transverse support device, the chambers being covered by the battery connection plates.

### FIELD OF THE INVENTION

This invention relates to a support structure for battery packs having a plurality of battery cells assembled together and requiring cooling and interconnection means. This invention also relates to a battery pack integrating a support structure. One application for such battery packs is for use in electrical vehicles.

### BACKGROUND OF THE INVENTION

Conventional battery packs for electric vehicles typically comprise battery cells mounted within a metallic housing of steel and/or aluminium having reinforcing elements to increase stiffness and integrity of the pack in the event of a crash. Since the batteries generate heat during use, battery cells are placed on a separate cooling plate mounted within the metallic housing. In order to ensure sufficient heat flow from the battery cells to the cooling element, it is known to provide a thermal interface material inserted between battery cells and the cooling element to improve contact and heat flow through conduction. Since battery cells need to be electrically interconnected, respectively connected to the external cable connected to the battery pack, it is typical to provide cells with a cell-to-cell bus bar for electrical interconnection of the cells.

Conventional battery packs have a number of drawbacks, including:
insufficient or non-homogeneous cooling of the battery cells which limits the energy density of the battery cells,
multiple assembly components for cooling, electrical connection and structural resistance which increase assembly complexity and manufacturing costs while reducing reliability
the need of a casing with high structural rigidity around the battery cells which increases weight and volume.

### SUMMARY OF THE INVENTION

It is an object of this invention to provide a battery pack structural assembly for a compact and lightweight battery pack with a high energy density.

It is an also an object of the present invention to provide a battery pack structural assembly that is robust and compact, yet enables efficient cooling of battery cells of the battery pack.

A specific object of this invention is to provide a battery pack and a structural assembly for a battery pack for automotive applications in particular.

It is advantageous to provide a battery pack structural assembly that is economical to manufacture.

It is advantageous to provide a battery pack structural assembly that is lightweight.

It is advantageous to provide a battery pack structural assembly that has a high crash resistance.

Objects of this invention have been achieved by providing the battery pack structural assembly according to claim 1 and the battery pack according to claim 20.

Disclosed herein is a battery pack structural assembly comprising a plurality of transverse support devices between which one or more groups of stacked battery cells may be mounted and electrically interconnected. Each transverse support device comprises a support frame and a plurality of battery connection plates mounted on the support frame, the battery connection plates having a conductive surface facing an outer side of the transverse support. The support frame comprises chambers formed therein interconnected fluidically to form at least one channel for circulation of cooling fluid through the transverse support device, the chambers being covered by the battery connection plates.

In an advantageous embodiment, adjacent chambers of said at least one channel are separated by chamber separation walls comprising orifices.

In an advantageous embodiment, the chamber separation walls extend at an intermediate angle with respect to both an X direction and a Y direction from a first side of the support frame to an opposite second side of the support frame, a plurality of successive chamber separation walls thus following a zigzag shape seen in a Z direction, whereby X, Y, and Z represent three mutually perpendicular axes of a cartesian reference system.

In an advantageous embodiment, the chambers are disposed on a first side of the support frame and an opposite second side of the support frame, said chambers on both said first and second sides being covered by the battery connection plates.

In an advantageous embodiment, the transverse support device comprises at least one fluid port on each of a first end and a second end of the support frame, the fluid port configured for coupling to a fluid interconnection shaft mounted between and fluidically interconnecting two spaced apart transverse support devices.

In an advantageous embodiment, the plurality of transverse support devices and a plurality of said fluid interconnection shafts form a serpentine structure.

In an advantageous embodiment, the support frame comprises a central separation wall separating two channels, each for circulation of cooling fluid through the transverse support device.

In an advantageous embodiment, the support frame comprises fixing sockets arranged on a peripheral wall of the support frame for securing walls of a casing to the transverse support device.

In an advantageous embodiment, the support frame is of made of an integrally formed body.

In an advantageous embodiment, the support frame is of made of a polymer, optionally incorporating a reinforcement material.

In an advantageous embodiment, said polymer is a thermoplastic resin.

In an advantageous embodiment, the thermoplastic resin is selected from
aliphatic polyamides, such as polyamide 66, polyamide 6, polyamide 11, polyamide 11, polyamide 12, polyamide 610, polyamide 66/610, polyamide 6/12, polyamide 666;
semi-aromatic polyamides, such as polyamides having all or a portion of their diacid units deriving from terephthalate and/or iso-phthalate, such as PA6T, polyamide 6IT, PA6T/66, PA6T/DT and PA6T/6I;
polyolefins, such as polypropylene;
polyesters, such as poly(butylene terephthalate), poly(ethylene terephthalate);
copolyetheresters, such as those having hard segments comprised of PBT, PET and/or PTT and soft segments comprised of poly(C2-4-alkylene oxide)diols;
polyphenylene sulfide (PPS);
polyacetal;
liquid-crystal polymers.

In an advantageous embodiment, the support frame is injection molded.

In an advantageous embodiment, the transverse support device has an elongate shape that fits in a paralepidid with a minimum rectangular cross-section of height H1, width W and length D, D being greater than Wand H1, and the height H1 being slightly greater that a height H2 of said battery cell.

In an advantageous embodiment, the support frame comprises side-to-side conductor elements which traverse a dielectric material of the support frame from a first side to an opposite second side and electrically interconnect battery connection plates mounted on said first and opposite second sides

In an advantageous embodiment, the side-to-side conductor elements are in the form of pins or rods.

In an advantageous embodiment, the battery connection plates are made of a conductive material, optionally coated on an inner side with an insulating material covering said chambers.

In an advantageous embodiment, the battery connection plates are made of a metal.

In an advantageous embodiment, the battery connection plates are sealingly bonded to the support frame by a weld connection.

Also disclosed herein is a battery pack comprising a battery pack structural assembly as set forth above, and a plurality of battery cells mounted and electrically interconnected between the transverse support devices. Each battery cell has a generally elongated rectangular shape with a height H2, length L and thickness T, L being greater than H2, the plurality of battery cells being stacked in the direction of their thickness T in the direction of a Y axis to form groups or modules, the transverse support device extending in the Y direction, and the length L of the battery cell oriented in the X direction, whereby X, Y, and Z represent three mutually perpendicular axes of a cartesian reference system. Electrical terminals of the battery cells arranged on ends of the battery cells are in contact with the battery connection plates.

In an advantageous embodiment, the battery pack further comprises a casing comprising top and bottom walls and side walls that encase a top, bottom and sides of the battery pack, the casing fixed at multiple fixing points to the transverse support devices of the battery pack structural assembly.

Further objects and advantageous aspects of the invention will be apparent from the claims, and from the following detailed description and accompanying figures.

### BRIEF DESCRIPTION OF THE DRAWINGS

The invention will now be described with reference to the accompanying drawings, which by way of example illustrate embodiments of the present invention and in which:

FIG. 1a is a schematic perspective view of a battery pack according to an embodiment of the invention;

FIG. 1b is a view of the battery pack of FIG. 1a with a top casing part removed;

FIG. 1c is a view similar to FIG. 1b with top and side casing parts removed;

FIG. 2 is a schematic perspective view of a pair of battery packs according to an embodiment of the invention placed one next to other;

FIG. 3a is a perspective view of a battery pack structural assembly of the battery pack of FIG. 1a with battery cells removed, according to an embodiment of the invention;

FIG. 3b is a perspective view of a part of the battery pack structural assembly of FIG. 3a with fluid interconnection shafts removed;

FIG. 3c is a perspective view of a part of the battery pack structural assembly of FIG. 3a showing a fluid interconnection shaft disassembled from a transverse support device;

FIG. 3d is a perspective view similar to FIG. 3b from the other side of the assembly;

FIG. 4a is a perspective view of a transverse support device of the battery pack structural assembly of FIG. 3a according to an embodiment of the invention;

FIG. 4b is a view similar to FIG. 4a with battery connection plates removed from the transverse support device;

FIG. 4c is a detailed cross-sectional view of a portion of the support frame shown in FIG. 4b;

FIG. 4d is a detailed cross-sectional perspective view of the transverse support device of FIG. 4a;

FIG. 5a is a detailed view of a connection portion of battery cells of a battery pack according to an embodiment of the invention;

FIG. 5b is a detailed view of a connection portion of battery cells and connection plates of a transverse support member with the support frame removed, of a battery pack according to an embodiment of the invention.

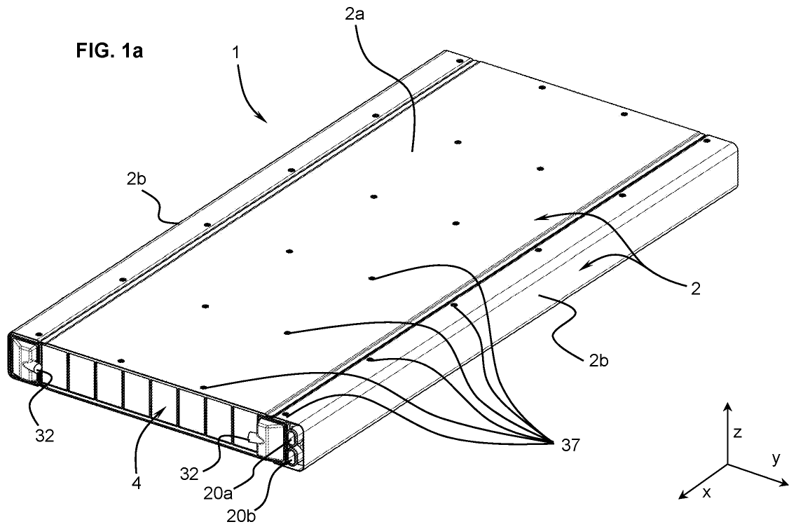

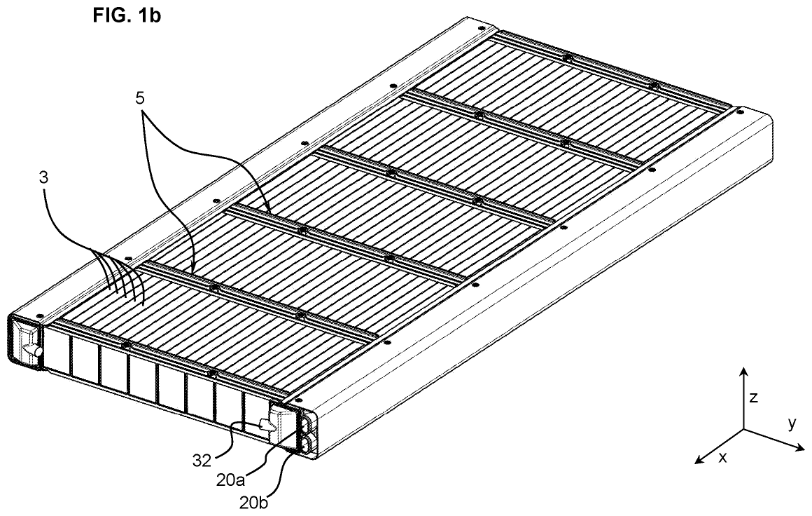

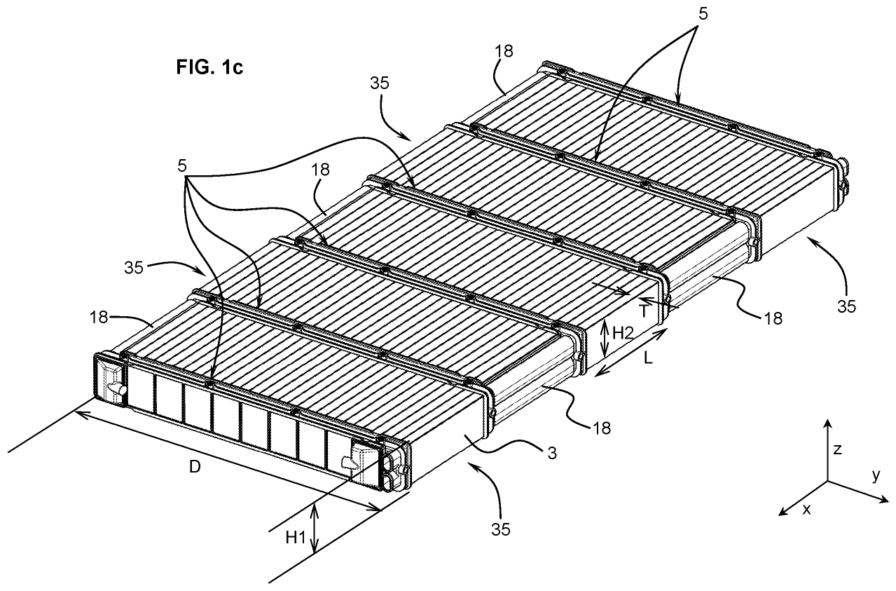

### DETAILED DESCRIPTION OF EMBODIMENTS OF THE INVENTION

Referring to the figures, a battery pack 1 comprises a plurality of battery cells 3 interconnected together within a battery pack structural assembly 4, and a casing 2 covering the battery cells and battery pack structural assembly.

Each of the battery cells comprises a cell body 22 and electrical terminals 26, each battery cell being rechargeable and comprising for instance a lithium ion electrical charge storage material as per se well known in the art. Other known battery types may also be used. As per se well known in the art, a plurality of battery cells may be connected in series to generate a certain voltage, and groups of cells may be interconnected together in parallel to supply a certain current.

An application of importance for battery packs 1 according to embodiments of the invention is for use in mobile applications, for instance in land vehicles such as electrical cars. Other mobile applications, for instance in aircraft and marine craft may also advantageously integrate the current invention. Battery packs may also be used for other applications in the industrial, commercial and residential fields as fixed or portable electrical charge storage devices without departing from the spirit of the invention.

The battery pack structural assembly 4 according to embodiments of the invention serves multiple purposes, including to provide structural rigidity for protection of the battery pack 1, to provide cooling of the battery cells 3, and for electrical interconnection of battery cells 3. The casing 2 comprises top and bottom walls 2a and side walls 2b that encase a top, bottom and sides of the battery pack. The casing is fixed at multiple fixing points 37 to the battery pack structural assembly to form a rigid lightweight construction that is compact and resistant to crushing forces and shocks. The battery pack structural assembly 4 comprises ports 20, 20a, 20b for injection and outflow of cooling fluid, and electrical connections 32, for instance cable connections or pluggable connectors for electrical connection to an external electrical supply and consumer system.

For ease of description, we shall refer herein to a cartesian system with three orthogonal axes X, Y, and Z (as illustrated in the figures), it being understood that choice of axes and nomenclature is merely to provide spatial references and orientation for describing the configuration of the battery pack. Each battery cell 3 has a generally rectangular shape with a height H2, length L and thickness T, L being greater than H2. In embodiments, the height H2 is greater than the thickness T, however in variants H2 may also be smaller than T.

The plurality of battery cells 3 are stacked in the direction of their thickness T in the direction of the Y axis to form groups or modules 35 that lie on an X-Y plane. A resistance against crushing in the Z direction, orthogonal to the X-Y plane in which the battery cells are mounted, is provided by transverse support devices 5 of the battery pack structural assembly 4. A resistance against crushing in the Y direction, in which the battery cells are stacked, is also provided by the transverse support devices 5 of the battery pack structural assembly 4.

The longitudinal orientation of the battery cells that have an elongated rectangular shape as illustrated in the figures, is arranged in the X direction. The battery cells 3 are arranged in groups 35 of stacked battery cells, mounted between transverse support devices 5 positioned on both longitudinals ends of the battery cells.

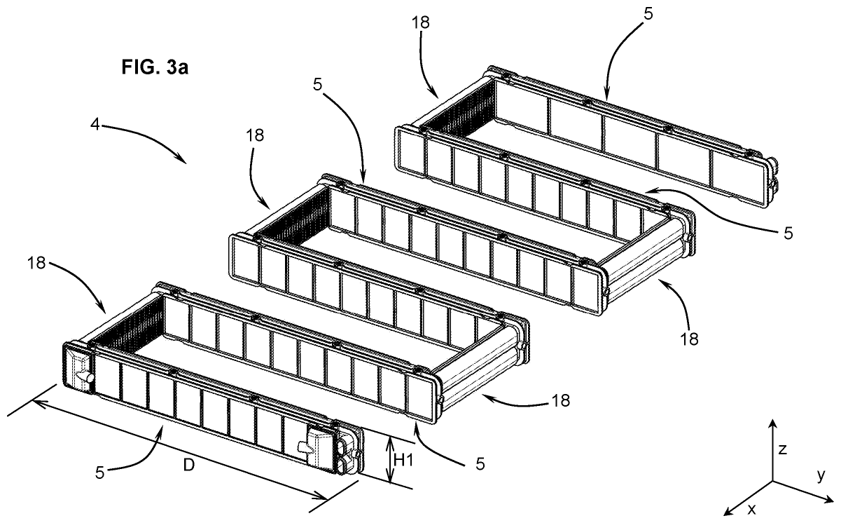

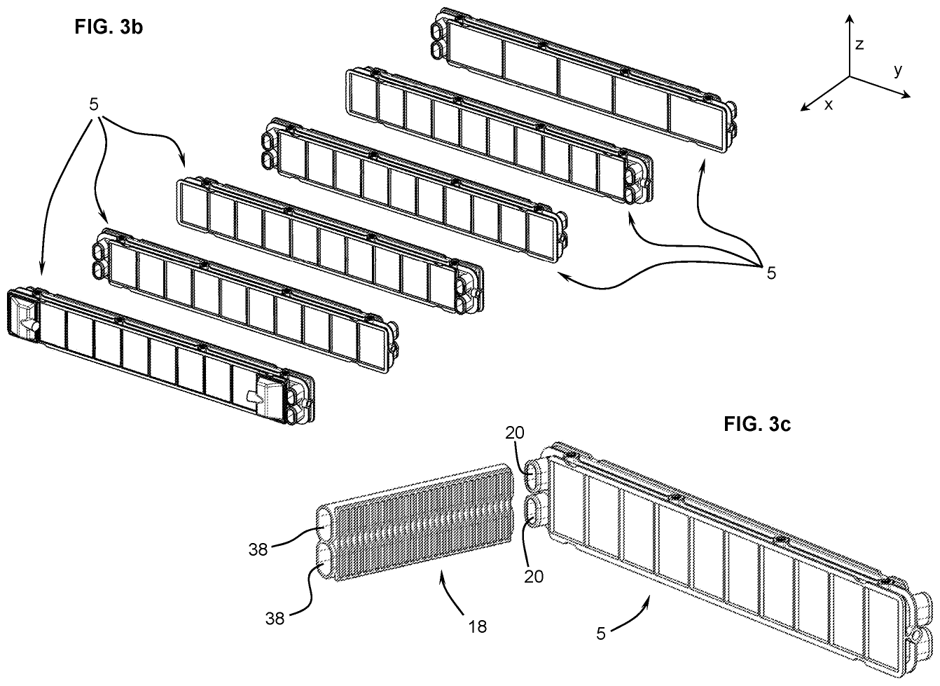

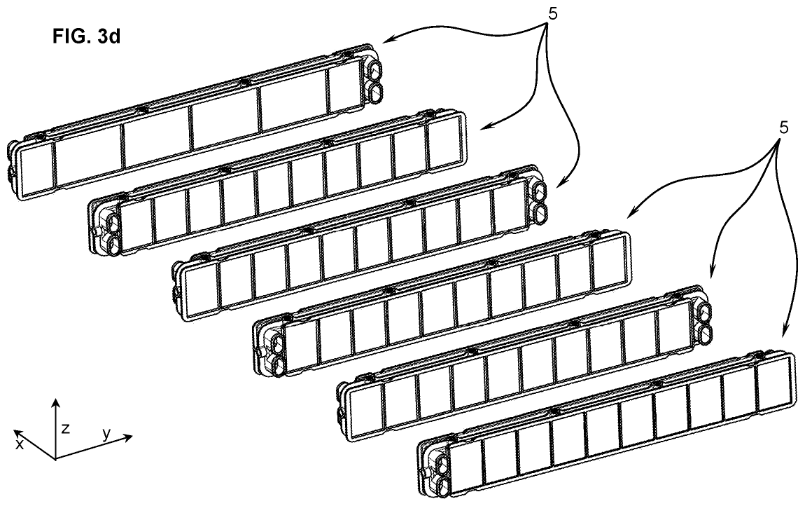

The transverse support devices 5 are interconnected together by fluid interconnection shafts 18 that serve principally to interconnect the transverse support devices with a fluidic connection for through-flow of cooling fluid. In an embodiment, the fluid interconnection shafts 18 are positioned alternatingly on different ends of the transverse support devices as best illustrated in FIG. 3a, thus forming a serpentine shape of the battery pack structural assembly 4.

Cooling fluid flowing through the transverse support devices 5 and fluid interconnection shafts 18 may thus circulate in a supply channel through the serpentine circuit path, and in a first variant, exit a port at an end of the serpentine circuit path distal from the cooling fluid entry port 20a. In another variant, the cooling fluid flows back through the serpentine circuit in a return channel separated from the supply channel, to exit from a port 20b at the same side as the entry port 20a into which the cooling fluid was injected.

Each transverse support device 5 comprises a support frame 6, advantageously in the form of a polymer body, optionally with reinforcing materials, preferably integrally formed, preferably injection moulded, although within the scope of the invention other materials and manufacturing processes may be used, for instance additive or subtractive manufacturing processes. Advantageously however an injection moulded process in which the support frame of the transverse support device may be moulded may be particularly advantageous from a manufacturing cost and structural rigidity perspective. The polymer may advantageously comprise a thermoplastic resin selected from:
aliphatic polyamides, such as polyamide 66, polyamide 6, polyamide 11, polyamide 11, polyamide 12, polyamide 610, polyamide 66/610, polyamide 6/12, polyamide 666;
semi-aromatic polyamides, such as polyamides having all or a portion of their diacid units deriving from terephthalate and/or iso-phthalate, such as PA6T, polyamide 6IT, PA6T/66, PA6T/DT and PA6T/6I;
polyolefins, such as polypropylene;
polyesters, such as poly(butylene terephthalate), poly(ethylene terephthalate);
copolyetheresters, such as those having hard segments comprised of PBT, PET and/or PTT and soft segments comprised of poly(C2-4-alkylene oxide)diols;
polyphenylene sulfide (PPS);
polyacetal;
liquid-crystal polymers.

The above thermoplastic resins may additionally and preferably have reinforcement incorporated in the form of fibres, flakes or plates of a reinforcing material such as glass, aramid, and/or carbon.

In embodiments where the coolant fluid comprises water and/or alcohols, the polymer used for support frame 6 is preferably selected from polyamides, in particular long-chain and/or semi-aromatic polyamides.

The transverse support device 5 has a shape that fits in a paralepidid with a minimum rectangular cross-section of height H1, width W and length D, where the height is in the Z direction, the width in the X direction, and the length in the Y direction of the previously defined cartesian system. The height H1 is slightly greater that the height H2 of the battery cell such that the battery cell does not extend in the Z direction beyond the top and bottom edges of the transverse support device.

The support frame 6 of each transverse support device 5 may have an identical configuration in order to reduce the number of components that need to be manufactured with different tooling. Each support frame 6 comprises a peripheral wall 7 surrounding a plurality of chambers 8 and a central separation wall 9 extending in the longitudinal X direction between first and second ends 7b of the peripheral wall 7. Top and bottom walls 7a of the peripheral wall 7 are spaced apart in the Z direction and form support surfaces for the opposed casing top and bottom sides 2a. First and second ends 7b of the peripheral wall 7 define support surfaces for the sides 2b of the casing 2.

The chambers 8 are defined by chamber separation walls 10 that extend at an intermediate angle with respect to both the X direction and Y direction from one side of the support frame to the other side, thus following an alternating zigzag shape seen in the Z direction. Each of the support walls 10 is provided with an orifice 11 so that cooling fluid can flow from one chamber to the next chamber through the alternatingly angled chamber separation walls 10. The orifices 11 and chambers 8 on one side of the central separation wall 9 are fluidically interconnected to form a first channel for flow of the cooling fluid, and the orifices 11 and chambers 8 on the other side of the central separation wall 9 are fluidically interconnected to form a second channel for flow of the cooling fluid.

The chamber separation walls 10 in zigzag fashion provide structural rigidity against crushing forces acting in the Z direction, namely crushing forces acting against the top and bottom casing elements 2a. The central separation wall 9 also provides structural rigidity to the support frame 6 and in embodiments may provide a wall that seals adjacent chambers in the Z direction so that the cooling fluid flowing through one side of the support frame is separated from the cooling fluid flowing on the other side of the support frame such that one side may represent a channel for the inflow and the other channel for the return flow. In certain embodiments however, both channels may be used for cooling fluid flowing in a same direction.

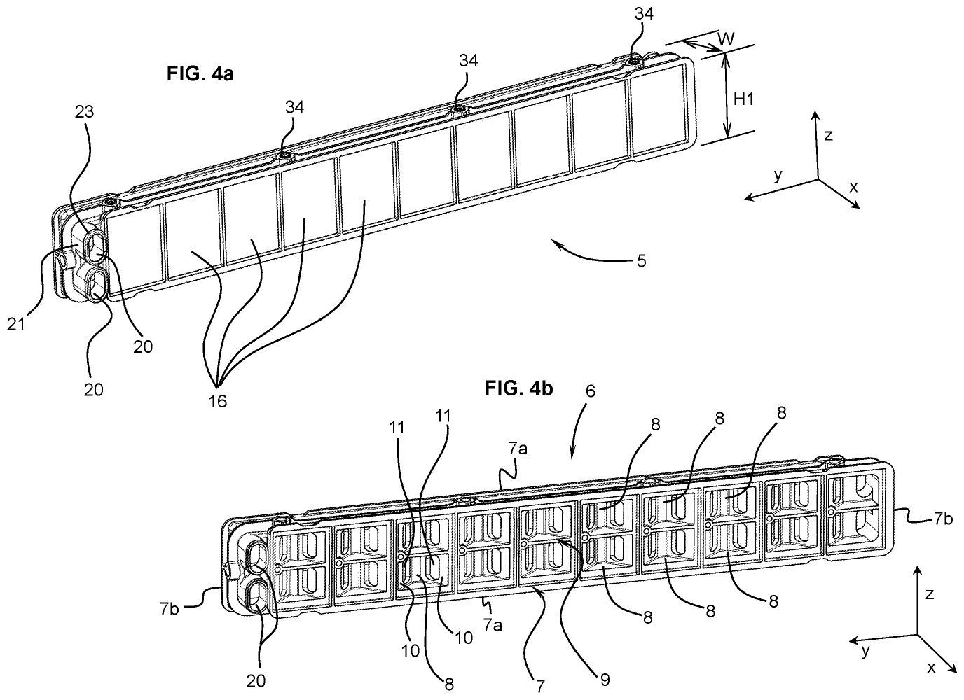

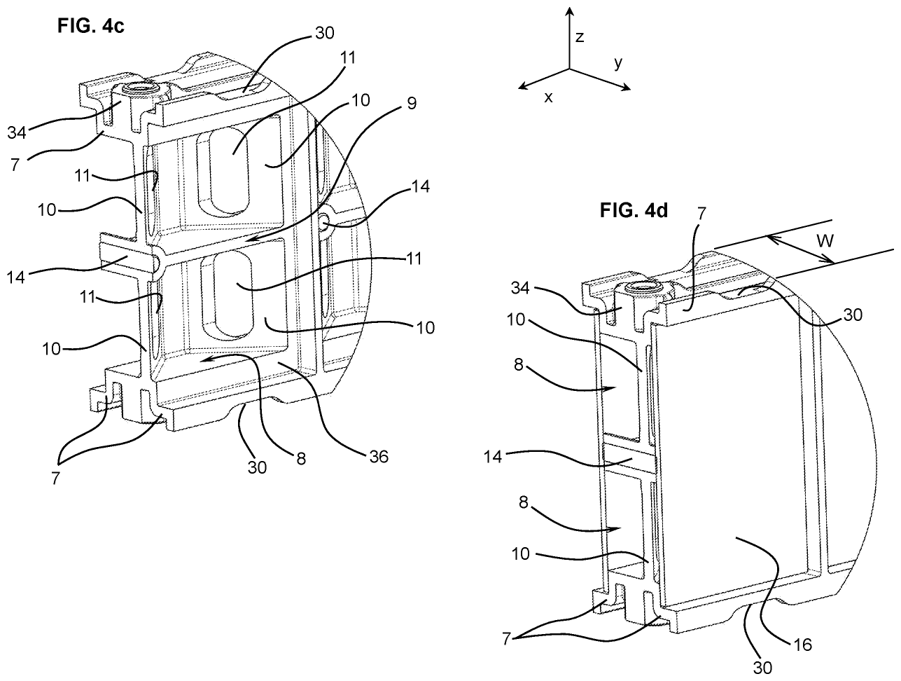

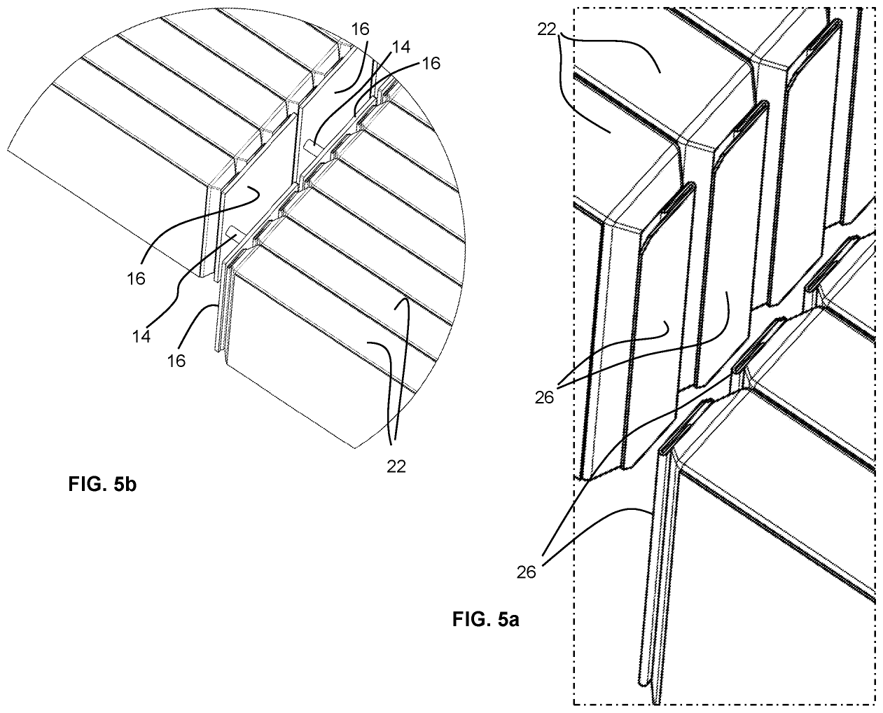

As illustrated in FIG. 4c, the support frame 6 in the X direction presents open chamber sides which allow the manufacturing with a die that opens and closes in the X direction. The open sides 36 of the chambers may be covered with a plate, in particular a battery connection plate 16. The battery connection plate 16 consists of or comprises a conductor, at least on the outer surface thereof, for electrical connection with electrical terminals on the longitudinal ends of the battery cells for connecting a plurality of battery cells together in series and in parallel connections according to the required electrical connection requirements. In an embodiment, the battery connection plate may be made of a conductive material, such as a metal, for instance, aluminium, copper, alloys thereof and other metals. The electrical terminals of the battery cells may be in a spring contact against the battery connection plates, but are preferably welded, brazed or soldered to the battery connection plates, either directly or via an interconnecting conductor element (not shown).

In order to interconnect battery connection plates 16 from one longitudinal side to the other longitudinal side of the support frame, side-to-side conductor elements 14 which, for instance may be in the form of connection posts or pins, traverse the dielectric material of the support frame 6 from one side to the other side. The side-to-side conductor elements 14 present conductive ends that are in contact with the plates 16 mounted over the chambers 8. Depending on the desired electrical interconnection schema, certain side-to-side conductor elements 14 may be missing or may be replaced by a non-conductive material simply providing support to the battery connection plate 16 pressed thereagainst. The side-to-side conductor elements 14 may have other configurations, however in a preferred embodiment a rod shape is particularly simple and allows easy assembly by insertion in cavities molded along different positions in the central separation wall 9, for instance as best illustrated in FIG. 4c.

The battery connection plate 16 may be sealingly bonded to a rim of the chamber 8 by bonding with an adhesive or by welding, for instance by ultrasound or heat welding to the polymer material of the support frame forming the rim.

The peripheral wall may advantageously be provided with fixing sockets 34 for rivet, screw or weld connections to secure the casing top and bottom walls 2a and the casing side walls 2b to the peripheral wall 7 of the support frame 6 at the fixing sockets 34. In an embodiment, the fixing sockets 34 may form an integral part of the support frame material, in particular a thermoplastic resin material, preferably reinforced. In another embodiment, the fixing sockets may comprise a metallic insert, or an insert of another robust material for fixing applications, that is inserted in the support structure, for instance by overmolding, bonding, welding or interference force fit.

At opposing ends of the support frame are provided fluid coupling ports 20. The fluid coupling ports 20 on one end of the support frame facing one side, and the fluid coupling ports on the opposite end facing the opposite side. One end of the support frame 6 may thus be coupled to a fluid interconnection shaft 18 on one side, and at the other end the support frame 6 couples to a fluid interconnection shaft 18 on the other side, thus forming a serpentine structure as illustrated in FIG. 3a.

The fluid interconnection shaft 18 comprises a fluid coupling port 38 with a coupling portion that engages over a shroud portion 21 of the fluid coupling port 20 on the support frame 6. A seal element 23, for instance in the form of an O-ring or other type of seal element is positioned between the interconnecting coupling and shroud portions and is preferably provided on the male element.

In order to provide air circulation or other cooling means between the casing to in particular the top and bottom walls 2a of the casing and the battery cells, the peripheral wall may further comprise indents 30 leaving gaps between the casing and the peripheral wall 7 for some circulation of gas therethrough.

Advantageously therefore, the plurality of transverse support devices 5 that serve both for cooling and electrical interconnection, also provide excellent structural rigidity with the zigzag form of the chamber separation walls 10 in a lightweight structure.

The casing 2 may be made of metallic sheets or alternatively of composite, polymer or other materials that are fixed to the peripheral wall 7 of the transverse support devices 5 so as to combine together to provide structural rigidity in a very lightweight construction.

Also, the plurality of transverse support devices 5 within the battery pack provide globally a high crushing force resistance both in the Z and Y directions and battery packs may thus be assembled within floors of electrical vehicles without additional structures to protect against crushing.

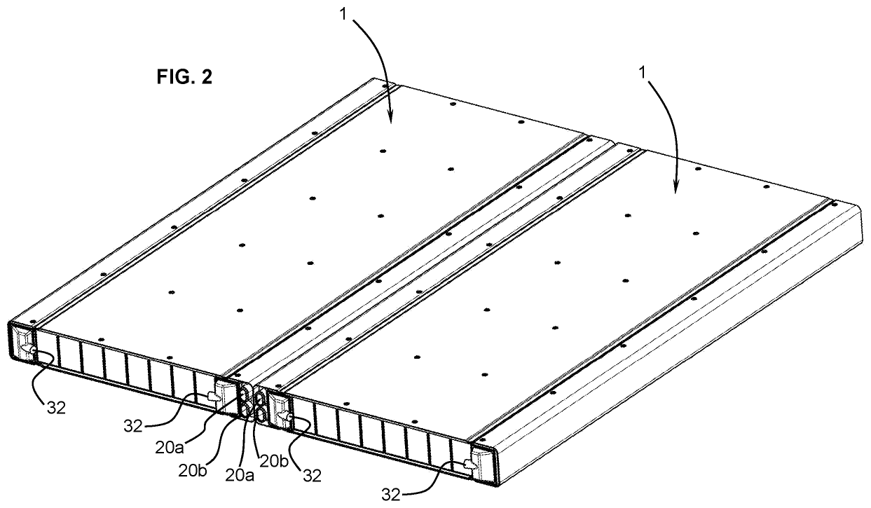

A compact low profile battery pack can thus be provided and may allow assembly with a very low profile one next to the other as illustrated in FIG. 2 or alternatively one on top of the other (not shown).

The electrical terminals of the battery cells provide a good conductor also for evacuation of heat out of the battery and into the battery connection plate 16. The battery connection plates 16 are in direct connection with cooling fluid in the fluid flow channels formed by the chambers 8 and orifices 11 within the support frame 6. The cooling fluid may advantageously be a dielectric fluid in which case the battery connection plate 16 does not need insulation on an inner side thereof. If the cooling fluid is an aqueous fluid or other fluid that is conductive, then the battery connection plates may have an insulating layer on the inner side, except for the position that contacts the side-to-side conductor element 14.

Although a serpentine configuration is illustrated in the embodiment of FIG. 3a, it would be possible to provide structural interconnection shafts on both sides of a battery module 35 for additional crushing strength (additional rigidity in the longitudinal direction X).

List of references used:

```
Battery pack 1
    groups or modules 35
  Casing 2
    Top, bottom walls 2a
    Side walls 2b
      fixing points 37
  Battery cell 3
    Cell body 22
      Connection ends 24
    Electrical terminals 26
  Battery pack structural assembly 4
    Transverse support device 5
      Support frame 6
        Peripheral wall 7
          Top, bottom walls 7a
            Fixing socket 34
          First end, second end 7b
            Groove 30
          Fluid coupling port 20, 20a, 20b
            Shroud 21
            Seal element 23
        Chamber 8
          Open side 36
        Central separation wall 9
        Chamber separation walls 10
          Orifice 11
      Electrical interconnection assembly
        Side-to-side conductor element 14
          Connection post
        Battery connection plate 16
        External connection 32
    Fluid interconnection shaft 18
      Fluid coupling port 38
        Coupling portion
        (Seal element)
```

1. Battery pack structural assembly comprising a plurality of transverse support devices between which one or more groups of stacked battery cells may be mounted and electrically interconnected, each transverse support device comprising a support frame and a plurality of battery connection plates mounted on the support frame, the battery connection plates having a conductive surface facing an outer side of the transverse support, the support frame comprising chambers formed therein interconnected fluidically to form at least one channel for circulation of cooling fluid through the transverse support device, the chambers being covered by the battery connection plates.

2. Battery pack structural assembly according to claim 1 wherein adjacent chambers of said at least one channel are separated by chamber separation walls comprising orifices.

3. Battery pack structural assembly according to the claim 2 wherein the chamber separation walls extend at an intermediate angle with respect to both an X direction and a Y direction from a first side of the support frame to an opposite second side of the support frame, a plurality of successive chamber separation walls thus following a zigzag shape seen in a Z direction, whereby X, Y, and Z represent three mutually perpendicular axes of a cartesian reference system.

4. Battery pack structural assembly according to claim 1 wherein the chambers are disposed on a first side of the support frame and an opposite second side of the support frame, said chambers on both said first and second sides being covered by the battery connection plates.

5. Battery pack structural assembly according to claim 1 wherein the transverse support device comprises at least one fluid port on each of a first end and a second end of the support frame, the fluid port configured for coupling to a fluid interconnection shaft mounted between and fluidically interconnecting two spaced apart transverse support devices.

6. Battery pack structural assembly according to claim 5 wherein the plurality of transverse support devices and a plurality of said fluid interconnection shafts form a serpentine structure.

7. Battery pack structural assembly according to claim 1 wherein the support frame comprises a central separation wall separating two channels, each for circulation of cooling fluid through the transverse support device.

8. Battery pack structural assembly according to claim 1 wherein the support frame comprises fixing sockets arranged on a peripheral wall of the support frame for securing walls of a casing to the transverse support device.

9. Battery pack structural assembly according to claim 1 wherein the support frame is of made of an integrally formed body.

10. Battery pack structural assembly according to claim 1 wherein the support frame is of made of a polymer, optionally incorporating a reinforcement material.

11. Battery pack structural assembly according to claim 10 wherein said polymer is a thermoplastic resin.

12. Battery pack structural assembly according to claim 11 wherein the thermoplastic resin is selected from
aliphatic polyamides, such as polyamide 66, polyamide 6, polyamide 11, polyamide 11, polyamide 12, polyamide 610, polyamide 66/610, polyamide 6/12, polyamide 666;
semi-aromatic polyamides, such as polyamides having all or a portion of their diacid units deriving from terephthalate and/or iso-phthalate, such as PA6T, polyamide 6IT, PA6T/66, PA6T/DT and PA6T/6I;
polyolefins, such as polypropylene;
polyesters, such as poly(butylene terephthalate), poly(ethylene terephthalate);
copolyetheresters, such as those having hard segments comprised of PBT, PET and/or PTT and soft segments comprised of poly(C2-4-alkylene oxide)diols; polyphenylene sulfide (PPS);
polyacetal;
liquid-crystal polymers.

13. (canceled)

14. Battery pack structural assembly according to claim 1 wherein the transverse support device has an elongate shape that fits in a paralepidid with a minimum rectangular cross-section of height H1, width W and length D, D being greater than W and H1, and the height H1 being slightly greater that a height H2 of said battery cell.

15. Battery pack structural assembly according to claim 1 wherein the support frame comprises side-to-side conductor elements which traverse a dielectric material of the support frame from a first side to an opposite second side and electrically interconnect battery connection plates mounted on said first and opposite second sides.

16. Battery pack structural assembly according to claim 1 wherein the side-to-side conductor elements are in the form of pins or rods.

17. Battery pack structural assembly according to claim 1 wherein the battery connection plates are made of a conductive material, optionally coated on an inner side with an insulating material covering said chambers.

18. Battery pack structural assembly according to claim 17 wherein the battery connection plates are made of a metal.

19. Battery pack structural assembly according to claim 1 wherein the battery connection plates are sealingly bonded to the support frame by a weld connection.

20. Battery pack comprising a battery pack structural assembly according to claim 1 and a plurality of battery cells mounted and electrically interconnected between the transverse support devices, each battery cell having a generally elongated rectangular shape with a height H2, length L and thickness T, L being greater than H2, the plurality of battery cells being stacked in the direction of their thickness T in the direction of a Y axis to form groups or modules, the transverse support device extending in the Y direction, and the length L of the battery cell oriented in the X direction, whereby X, Y, and Z represent three mutually perpendicular axes of a cartesian reference system, electrical terminals of the battery cells arranged on ends of the battery cells in contact with the battery connection plates.

21. Battery pack according to claim 20 further comprising a casing comprising top and bottom walls and side walls that encase a top, bottom and sides of the battery pack, the casing fixed at multiple fixing points to the transverse support devices of the battery pack structural assembly.
